(19) United States
(12) Patent Application Publication
(10) Pub. No.: US 2011/0043012 A1
(43) Pub. Date: Feb. 24, 2011

(54) DISPOSABLE PROTECTIVE MAT

(76) Inventor: CHARLOTTE WERNER, Celebration, FL (US)

Correspondence Address: MALDJIAN LAW GROUP LLC, 36 BINGHAM AVENUE, RUMSON, NJ, 07760, US

(21) Appl. No.: 12/862,037

(22) Filed: Aug. 24, 2010

Related U.S. Application Data
(60) Provisional application No. 61/236,292, filed on Aug. 24, 2009.

(51) Int. Cl. A47D 1/00; B32B 3/10

(52) U.S. Cl. 297/219.12; 428/195.1; 428/141; 428/172; 428/211.1; 428/80; 428/66.5

(57) ABSTRACT

In one embodiment, a disposable protective mat comprises a blank of material consisting of comprises one of paper, a cellulose-based product, polylactic acid (PLA), poly-3-hydroxybutyrate (PHB), polyamide 11 (PA 11), bio-derived polyethylene or combinations thereof, the blank of material shaped as a square having sides of about 37.5 inches in length, and having a thickness of between about 0.5 mils to about 36 mils thick; a position indicator on a top surface of the blank of material for aligning a highchair thereover, the position indicator comprising a dyed pattern on the top surface of the disposable protective mat; and wherein the blank of material comprises a decorative pattern on a top surface thereof, the pattern comprising one of ridges, bumps, grooves, repeating figures, characters, cartoon characters, animated designs or combinations thereof.

### CROSS-REFERENCE TO RELATED APPLICATIONS

This application claims priority to pending U.S. Provisional Patent Application Ser. No. 61/236,292, entitled “Disposable Protective Mat,” filed Aug. 24, 2009, the disclosure of which is incorporated herein by reference.

### BACKGROUND

1. Field of the Invention

Embodiments of the present invention generally relate to a disposable protective mat. More specifically, embodiments of the present invention relate to a disposable protective mat for placement under a chair, high chair, child seat, etc. used in the context of the food service industry or similar setting to protect against stains and contamination of a floor.

2. Description of the Related Art

The food service industry generally attracts clientele of all ages, ranging from infants and toddlers to senior citizens. As such, businesses and individuals involved in this industry are faced with a series of challenges which require the industry to adapt to the needs of their clients, as well as to maintain appropriate health and safety standards.

Generally speaking, infants and toddlers often leave behind pieces of food, bits of sauce, and other food items after completing a meal. This can be of particular concern at restaurants and in other service facilities, as these bits of food can attract pests, such as insects and rodents (e.g., ants, flies, roaches, mice) and may present a hazard to the safety and well-being of a food service worker or customer (e.g., by causing a floor to become slippery). Such hazards can rapidly become problematic, especially if no one is aware of the presence of stray food particles in an afflicted area.

Previous attempts to emolliate the effects of this problem have come in the form of rubber or polymeric mats which can be configured to sit underneath a child's high chair or other seat, thus catching food and other splatter falling to the floor as discarded by the child. However, such mats are designed for multiple use applications, and as such, must be regularly cleaned and washed, which makes them rather unpractical for use in commercial applications (e.g., restaurants).

Thus, there exists a need for a disposable protective mat.

### SUMMARY

Embodiments of the present invention generally relate to a disposable protective mat. More specifically, embodiments of the present invention relate to a disposable protective mat for placement under a chair, high chair, child seat, etc. used in the context of the food service industry or similar setting to protect against stains and contamination of a floor.

In one embodiment of the present invention, a disposable protective mat comprises a blank of material sized to accommodate a seating apparatus, wherein the blank of material comprises a position indicator for aligning the seating apparatus thereover.

In another embodiment of the present invention, a disposable protective mat and chair assembly comprises a blank of material sized to accommodate a chair, a position indicator on a top surface of the blank of material for aligning the chair thereover, and wherein the chair comprises a highchair for a child.

In yet another embodiment of the present invention, a disposable protective mat consists of a blank of material consisting of comprises one of paper, a cellulose-based product, polylactic acid (PLA), poly-3-hydroxybutyrate (PHB), polyamide 11 (PA 11), bio-derived polyethylene or combinations thereof, the blank of material shaped as a square having sides of about 37.5 inches in length, and having a thickness of between about 0.5 mils to about 36 mils thick; a position indicator on a top surface of the blank of material for aligning a highchair thereover, the position indicator comprising a dyed pattern on the top surface of the disposable protective mat; and wherein the blank of material comprises a decorative pattern on a top surface thereof, the pattern comprising one of ridges, bumps, grooves, repeating figures, characters, cartoon characters, animated designs or combinations thereof.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1a depicts a disposable protective mat in accordance with one embodiment of the present invention;

FIG. 1b depicts the disposable protective mat of FIG. 1a further comprising placement guides in accordance with another embodiment of the present invention; and

FIG. 1c depicts the disposable protective mat of FIG. 1b in operation with a chair in accordance with another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

As used herein, the term “chair” and any derivative term thereof may refer to any seat or chair, including but not limited to kitchen chairs, child high chairs, or any other seat or chair feasible in the context of the present invention.

Embodiments of the present invention generally relate to a disposable protective mat. More specifically, embodiments of the present invention relate to a disposable protective mat for placement under a chair, high chair, child seat, etc. used in the context of the food service industry or similar setting to protect against stains and contamination of a floor.

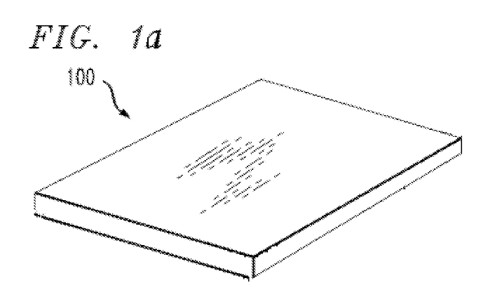

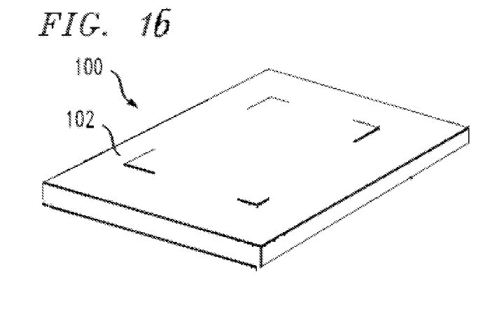

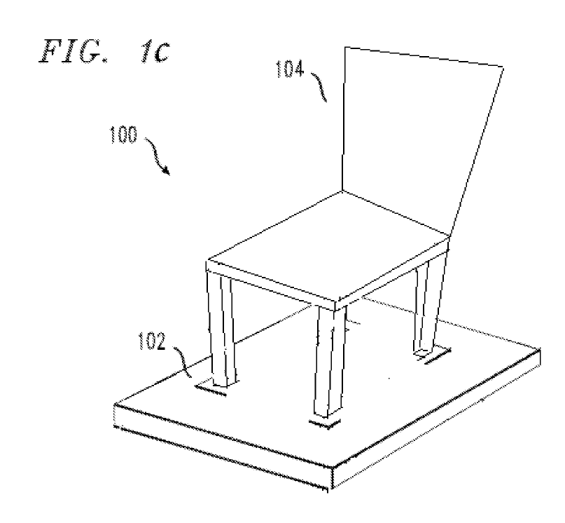

FIG. 1a depicts a disposable protective mat 100 in accordance with one embodiment of the present invention. Such a disposable protective mat 100 may comprise any material feasible in the context of the present invention and practical for applications required of the disposable protective mat 100, including but not limited to cloth, plastic (e.g., polyethylene, polypropylene), paper, cardboard, recycled material, or any combination thereof.

In accordance with one embodiment of the present invention, the disposable protective mat 100 is biodegradable. In such an embodiment, the disposable protective mat 100 may comprise paper, other cellulose-based products (e.g., cellophane), polylactic acid (PLA), poly-3-hydroxybutyrate (PHB), polyamide 11 (PA 11), bio-derived polyethylene, recycled combinations of any of the above, or combinations thereof. In this manner, the disposable protective mat 100, when disposed of and placed in a landfill or compost pile, will substantially biodegrade, leaving behind carbon dioxide and water as waste products.

Although depicted in FIGS. 1a through 1c as a rectangle or square, it should be noted that the disposable protective mat 100 may take any shape or combination of shapes. Such shapes may include two-dimensional geometric shapes, such as triangles, squares, rectangles, circles, ovals, polygons, etc.; three-dimensional geometric shapes, such as spheres, cylinders, pyramids, etc.; any non-geometric shape (e.g., non-rigid or freehand-type shapes); any other planar or multi-planar shape feasible in the context of the present invention; or any combination thereof.

The disposable protective mat 100 may additionally have any dimensions feasible in the context of the present invention. For example, in accordance with embodiments of the present invention, the disposable protective mat 100 may be substantially square and measure from between about 32 inches to about 48 inches square. In one specific embodiment, the disposable protective mat 100 is about 37.5 inches square.

A disposable protective mat 100 may have any thickness feasible in the context of the present invention. Although the Figures depict a disposable protective mat 100 having a substantial thickness with respect to its length and width, it should be appreciated that the thickness shown in the Figures is for exemplary display purposes only. In many embodiments, of the present invention, the thickness of the disposable protective mat 100 may range from between about 0.5 mils to about 36 mils thick. Generally, however, the thickness will be dependent upon the type of material used to create the disposable protective mat 100.

Furthermore, the disposable protective mat 100 may comprise a pattern or a plurality of patterns disposed thereon. Such patterns may include, but are not limited to, ridges, bumps, grooves, repeating figures (e.g., spirals, dots), characters (e.g., letters, numbers, punctuation, characters, and combinations thereof), cartoon characters, animated designs or any combination thereof, each of which may be raised, depressed, or level relative to any point on the surface of the disposable protective mat 100. The edges of the disposable protective mat 100 may additionally be decorated or patterned, as by scalloping or zigzagging, or may alternatively be clean cut.

The disposable protective mat 100 may also take on any color or combination of colors feasible in the context of the present invention. Such color or plurality of colors may be painted, dyed, drawn, or otherwise disposed on or in the disposable protective mat 100. For example, in accordance with one embodiment of the present invention, the disposable protective mat 100 is substantially green or various shades thereof.

Referring now to FIG. 1b, in accordance with another embodiment of the present invention, a disposable protective mat 100 may further comprise one or more placement guides 102. The placement guides 102 are provided on the disposable protective mat 100 to guide a user to properly configure the disposable protective mat 100 to achieve an intended purpose. Specifically, in accordance with one embodiment of the present invention, the placement guides 102 may constitute a portion or all of the outline or projection of a chair such that a user may align the chair with the placement guides 102 to ensure proper placement for optimal results with the disposable protective mat 100.

Although depicted in FIG. 1b as outlining the corners of a square or rectangular object, it should be noted that the inventor contemplates any number of implementations and embodiments for the placement guides 102, including but not limited to the outline of a zone encompassing at least a portion of the chair, the outline of any one or more of the feet of a chair (e.g., dots, circles, squares, etc. within which a user can place the feet of the chair), any other placement guide implementations feasible in the context of the present invention, or any combination thereof. As such, placement guides 102 may take the form of a single placement guide 102, as in a single zone (as described above), or may be more than one indication (as in outlines of the feet of a multi-footed chair).

Placement guides 102 can be physically implemented in or on the disposable protective mat 100 in any manner feasible in the context of the present invention. For example, one or more placement guides 102 may be dyed into the disposable protective mat 100, as a color and/or pattern which is visually distinct from the remainder of the disposable protective mat 100. Alternatively, one or more placement guides 102 may be physically disposed on the disposable protective mat 100, as in strips of tape or paper strips which may be connected to the disposable protective mat 100, via an adhesive composition or other method, and which implement an intended purpose as described hereinabove. In yet another alternative embodiment, one or more placement guides 102 may be painted or drawn on the disposable protective mat 100. It should also be noted that the inventor contemplates implementing any combination of these implementation methods and/or any other implementation method feasible in the context of the present invention (e.g., painting placement guides 102 to guide two feet of a four-legged chair, and placing adhesive tape as placement guides 102 to guide the remaining two feet; painting a substantially circular zone as a placement guide 102 and outlining the painted circular zone with adhesive tape; etc.).

Referring now to FIG. 1c, a disposable protective mat 100 is shown in operation in conjunction with a chair 104. As described with reference to FIGS. 1a and 1b, a disposable protective mat 100 may be configured on a floor or other surface upon which there is a potential for hazards as described hereinabove. A chair 104 may be disposed upon the disposable protective mat 100 as shown in FIG. 1c. In order to align the chair 104 properly, and in order to insure that the disposable protective mat 100 performs optimally, the corners or outline of the chair 104 (depicted in FIG. 1c as the four feet of a four-legged chair) may be aligned with one or more placement guides 102 as described hereinabove.

In operation, an individual sits in the chair 104 in preparation for conducting an activity which has a potential for creating sanitary and/or physical hazards (e.g., food on the floor). Such hazards may occur in any one or more settings, including but not limited to a food service setting (e.g., a restaurant), an indoor pool environment, or any other environment or set of circumstances feasible in the context of the present invention.

When conducting an activity which poses the threat of potential sanitary and/or physical hazard, food, water, or other potentially hazard-posing substances may fall from the individual's activity space (e.g., a table, a lap) down to the disposable protective mat 100. As such, the disposable protective mat 100 may become soiled or dirty, having food or other material disposed thereon and/or therein (e.g., as through absorption).

When the individual has completed his/her activity, or when the disposable protective mat 100 has become sufficiently soiled or saturated, a user may dispose of the disposable protective mat 100 in the trash or by other means. When the user removes the disposable protective mat 100 out from under the chair 104, thus revealing the floor or other protected surface, the floor or surface will be substantially cleaner and less hazardous than if the disposable protective mat 100 had not been present, thus allowing the food, water, and/or other splatter to fall directly onto the floor or surface. When another potentially hazardous situation presents itself, a new disposable protective mat 100 may be configured in a similar manner as described hereinabove.

Such disposable protective mats 100 may be presented to a consumer in a number of different manners. In accordance with one embodiment of the present invention, disposable protective mats 100 may be packaged and/or sold separately, or in amounts of one, two, five, ten, twenty-five, fifty, etc. In such a manner, the disposable protective mats 100 may be packaged and/or sold in the form of a roll, intertwined stack, in the form of a kit, etc. In accordance with another embodiment of the present invention, the disposable protective mats 100 may be packaged and/or sold in conjunction with a dispenser and/or applicator device.

While the foregoing is directed to embodiments of the present invention, other and further embodiments of the invention may be devised without departing from the basic scope thereof.

What is claimed is:

1. A disposable protective mat comprising:
a blank of material sized to accommodate a seating apparatus;
wherein the blank of material comprises a position indicator for aligning the seating apparatus thereover.

2. The disposable protective mat of claim 1, wherein the blank of material comprises one of paper, a cellulose-based product, polylactic acid (PLA), poly-3-hydroxybutyrate (PHB), polyamide 11 (PA 11), bio-derived polyethylene or combinations thereof.

3. The disposable protective mat of claim 1, wherein the blank of material is substantially shaped as one of a rectangle, square, triangle, circle, oval, polygon or combinations thereof.

4. The disposable protective mat of claim 3, wherein the blank of material comprises a square having sides between about 32 inches to about 48 inches in length.

5. The disposable protective mat of claim 4, wherein the blank of material comprises sides about 37.5 inches in length.

6. The disposable protective mat of claim 1, wherein the blank of material comprises a thickness between about 0.5 mils to about 36 mils.

7. The disposable protective mat of claim 1, wherein the blank of material comprises a decorative pattern on a top surface thereof.

8. The disposable protective mat of claim 7, wherein the pattern comprises one of ridges, bumps, grooves, repeating figures, characters, cartoon characters, animated designs or combinations thereof.

9. The disposable protective mat of claim 1, wherein the position indicator comprises a dyed pattern on a top surface of the disposable protective mat.

10. The disposable protective mat of claim 1, wherein the disposable protective mat consists of biodegradable materials.

11. A disposable protective mat and chair assembly comprising:
a blank of material sized to accommodate a chair;
a position indicator on a top surface of the blank of material for aligning the chair thereover; and
wherein the chair comprises a highchair for a child.

12. The disposable protective mat and chair assembly of claim 11, wherein the blank of material comprises one of paper, a cellulose-based product, polylactic acid (PLA), poly-3-hydroxybutyrate (PHB), polyamide 11 (PA 11), bio-derived polyethylene or combinations thereof.

13. The disposable protective mat and chair assembly of claim 11, wherein the blank of material is substantially shaped as one of a rectangle, square, triangle, circle, oval, polygon or combinations thereof.

14. The disposable protective mat and chair assembly of claim 13, wherein the blank of material comprises a square having sides between about 32 inches to about 48 inches in length.

15. The disposable protective mat and chair assembly of claim 14, wherein the blank of material comprises sides about 37.5 inches in length.

16. The disposable protective mat and chair assembly of claim 11, wherein the blank of material comprises a thickness between about 0.5 mils to about 36 mils.

17. The disposable protective mat and chair assembly of claim 11, wherein the blank of material comprises a decorative pattern on a top surface thereof, the pattern comprising one of ridges, bumps, grooves, repeating figures, characters, cartoon characters, animated designs or combinations thereof.

18. The disposable protective mat and chair assembly of claim 11, wherein the position indicator comprises a dyed pattern on a top surface of the disposable protective mat.

19. The disposable protective mat and chair assembly of claim 19, wherein the disposable protective mat consists of biodegradable materials.

20. A disposable protective mat consisting of:
a blank of material consisting of comprises one of paper, a cellulose-based product, polylactic acid (PLA), poly-3-hydroxybutyrate (PHB), polyamide 11 (PA 11), bio-derived polyethylene or combinations thereof, the blank of material shaped as a square having sides of about 37.5 inches in length, and having a thickness of between about 0.5 mils to about 36 mils thick;
a position indicator on a top surface of the blank of material for aligning a highchair thereover, the position indicator comprising a dyed pattern on the top surface; and
wherein the blank of material comprises a decorative pattern on a top surface thereof, the pattern comprising one of ridges, bumps, grooves, repeating figures, characters, cartoon characters, animated designs or combinations thereof.
